(19) United States
(12) Patent Application Publication
(10) Pub. No.: US 2019/0207801 A1
(43) Pub. Date: Jul. 4, 2019

(54) System and Method for Rule-Based Simple Network Management Protocol Agent

(71) Applicant: DELL PRODUCTS, LP, Round Rock, TX (US)

(72) Inventors: Kwangsuk Kim, Santa Clara, CA (US); Dhanakumar Subramanian, Santa Clara, CA (US); Amruta Sali, Fremont, CA (US)

(21) Appl. No.: 15/859,052

(22) Filed: Dec. 29, 2017

(51) Int. Cl. H04L 12/24; G06F 9/54

(52) U.S. Cl. CPC H04L 41/0213; H04L 41/046; G06F 9/54

(57) ABSTRACT

An information handling system to reads a first network device parameter from a first data source on a first network device, and reads a second network device parameter from a second data source on a second network device. The information handling system stores a first data object based on the first network device parameter in a management information base (MIB), and stores a second data object based on the second network device parameter in the MIB. The information handling system maps the first network device parameter to the first data object to establish a first mapping, maps the second network device parameter to the second data object to establish a second mapping, and receives a first simple network management protocol (SNMP) request pertaining to the first data object. The information handling system dispatches the first request pertaining to the first data object to the first network device to perform a first access operation with respect to the first network device parameter according to the first mapping, and receives a second SNMP request pertaining to the second data object. The information handling system dispatches a second request pertaining to the second data object to the second network device to perform a second access operation with respect to the second network device parameter according to the second mapping.

### FIELD OF THE DISCLOSURE

The present disclosure generally relates to information handling systems, and more particularly relates to a simple network management protocol (SNMP) agent.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system reads a first network device parameter from a first data source on a first network device, and reads a second network device parameter from a second data source on a second network device. The information handling system stores a first data object based on the first network device parameter in a management information base (MIB), and stores a second data object based on the second network device parameter in the MIB. The information handling system maps the first network device parameter to the first data object to establish a first mapping, maps the second network device parameter to the second data object to establish a second mapping, and receives a first simple network management protocol (SNMP) request pertaining to the first data object. The information handling system dispatches the first request pertaining to the first data object to the first network device to perform a first access operation with respect to the first network device parameter according to the first mapping, and receives a second SNMP request pertaining to the second data object. The information handling system dispatches a second request pertaining to the second data object to the second network device to perform a second access operation with respect to the second network device parameter according to the second mapping.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according, to an embodiment of the present disclosure.

FIG. 2 is a flow diagram illustrating a system in accordance with at least one embodiment.

FIG. 3 is a block diagram illustrating a system in accordance with at least one embodiment.

FIG. 4 is a block diagram illustrating classes for a simple network management protocol application programming interface (SNMP-API) library in accordance with at least one embodiment.

FIG. 5 is a flow diagram illustrating a method in accordance with at least one embodiment.

FIG. 6 is a flow diagram illustrating a method in accordance with at least one embodiment.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

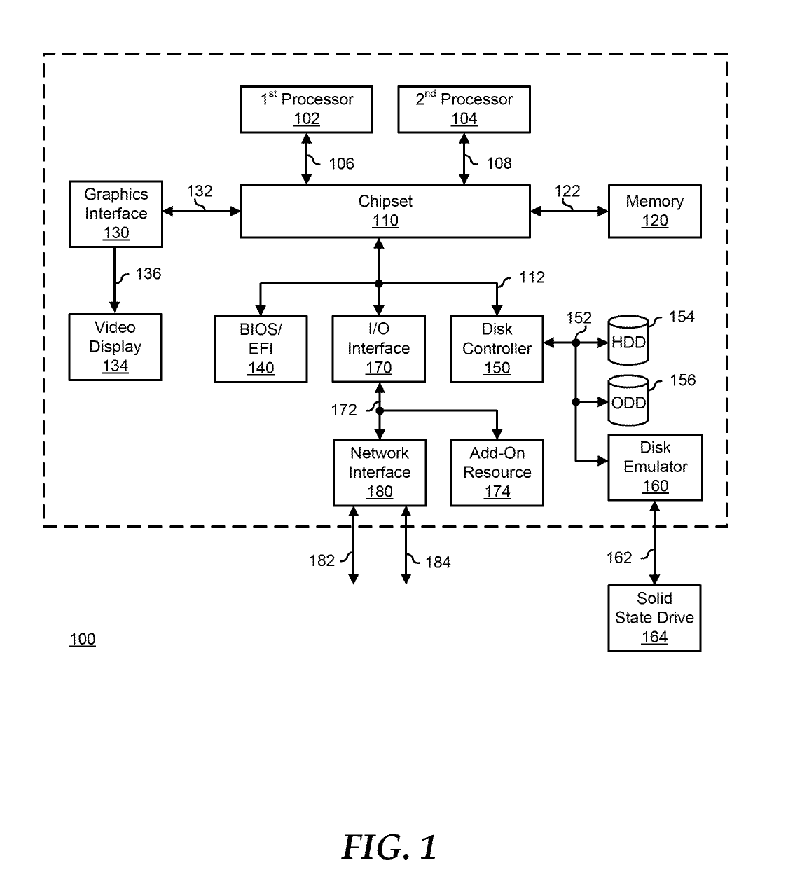

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

A network management system implementing a network management protocol can be used to manage objects connected to a network. One example of a network management protocol is the Simple Network Management Protocol (SNMP). A network management system implementing a network management protocol can store and retrieve information descriptive of managed objects at a Management Information Base (MIB). A network management system can implement a network management agent, such as an SNMP agent, to process information stored in a MIB or to produce a result to be stored in the MIB with respect to the managed objects.

Typically, an SNMP agent implemented by network vendors provides MIB object readings through standard or proprietary MIBs. Network vendors implement the SNMP agent applications with the vendor's choice of SNMP agent package and tools, like inter-process communication (IPC), data format, etc. specific to the vendor's network operation system.

Network developers typically need to write a code for the SNMP agent to access data sources to implement a MIB for SNMP operations, such as SNMP get, get-next, and set. Some networks vendors use the MIB complier to parse MIBs to generate the stub codes to ease the writing of data access code for MIB implementation. Typical stub codes have code duplication with different data structures to support a new MIB implementation. Network vendors also define objects to abstract the network services, where the structure may be tightly designed to support the target services, but not for other services, like SNMP operations. As a traditional MIB is structured in flattened data while network objects are hierarchically structured, structure duplication can occur for each MIB supported. Therefore, overall development practice usually takes time to implement MIB applications, and sometimes development practices are repeated many times to deliver the desired output.

In accordance with at least one embodiment, network developers from both network device vendors and customers can rapidly develop and extend SNMP MIB applications in a simple, pluggable manner to provide network management.

In accordance with at least one embodiment, an SNMP agent accesses data sources on a network device to read data-like interface counters, hardware version information, and other parameters. The SNMP agent also detects outstanding conditions and sends SNMP traps to subscribers.

Data stored in a MIB can be organized in either a tabular format or a scalar format. Each data object is identified by a unique object identifier (OID). An object identifier corresponds to a data object that maintains a value in a static register or internal database, such as a route table.

Access to data objects on a network device is typically operated through inter-process communication (IPC). An addressable object and its attributes are abstracted as network objects specific to network vendor implementation. The terms “objects” and “attributes” can be shown to be in a containment relationship, such that a network object contains one or more attributes.

In accordance with at least one embodiment, the need for data access codes can be eliminated by using a generic IPC command handler and mapping rule between network objects and MIB objects to rapidly enable SNMP agent development. A generic IPC command handler has basic public methods—get, test and set—for SNMP operations. A mapping rule uses a Javascript Object Notation (JSON) structure to define a directive how to map MIB object to the addressable network objects on the devices. Mapping rules are used by command handler to dynamically dispatch the requests to the data source to access the network objects. In accordance with at least one embodiment, the generic command handler is implemented using a SNMP application programming interface (API) library.

Network device vendors define various system objects to abstract network services to operate services using system resources, such as a processor, memory, input-output (I/O) drivers, etc. An SNMP agent, as implemented, for example, by network vendors, provides MIB object readings through MIB s. However, since application objects are often structured to promote system performance, MIB objects may not be well aligned with application objects in terms of data relation and operations. By providing a simple, rule-based mapping system and method between system or application objects and MIB objects, network developers can be enabled to rapidly develop and extend SNMP MIB applications for network management.

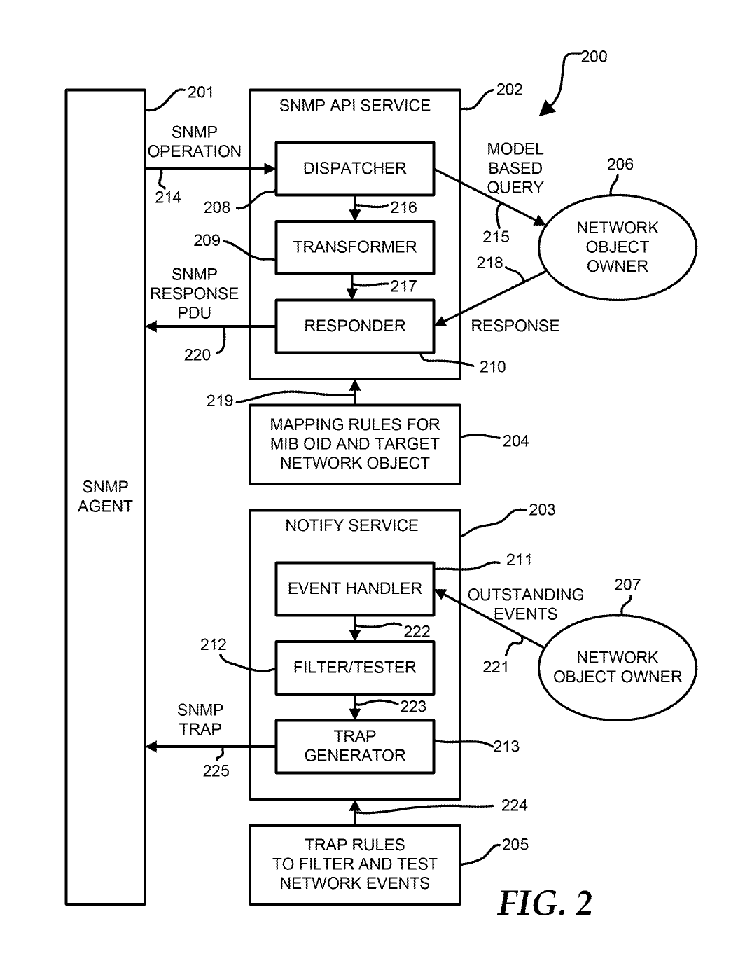

FIG. 2 shows a system 200 including SNMP agent 201, SNMP application programming interface (API) service 202, notify service 203, mapping rules 204 for MIB object identifier (OID) and target network object, trap rules 205 to filter and test network events, network object owner 206, and network object owner 207. In accordance with at least one embodiment, network object owner 206 and network object owner 207 are different network object owners. In accordance with at least one embodiment, network object owner 206 and network object owner 207 are the same network object owner.

SNMP API service 202 comprises dispatcher 208, transformer 209, and responder 210. SNMP API service 202 receives mapping rules 204 for MIB OID and target network object via input 219. SNMP API service 202 performs the following operations in accordance with the mapping rules 204. SNMP agent 201 sends a SNMP operation 214 to dispatcher 208. Dispatcher 208 sends the SNMP operation to transformer 209 via output 216 and sends a model-based query 215 to network object owner 206. Transformer 209 transformers the SNMP operation and provides an output 217 to responder 210. Network object owner 206 provides a response 218 to responder 210 in response to the model-based query 215. Responder 210 provides a SNMP response packet data unit (PDU) 220 to SNMP agent 201.

Notify service 203 comprises event handler 211, filter and tester 212, and trap generator 213. In accordance with at least one embodiment, notify service 203 may be a SNMP notify service. Notify service 203 receives trap rules 205 to filter and test network events via input 224. Notify service 203 performs the following operations in accordance with the trap rules 205. Event handler 211 of notify service 203 receives indications of outstanding events 221 from network object owner 207. Event handler 211 provides the indications to filter and tester 212 of notify service 203 via output 222. Filter and tester 212 can perform filtering or testing of the indications of the outstanding events based on trap rules 205. Filter and tester 212 provides filtered indications of outstanding events (which may include tested indications of outstanding events) to trap generator 213 via output 223. Trap generator 213 generates a SNMP trap 225 and provides it to SNMP agent 201.

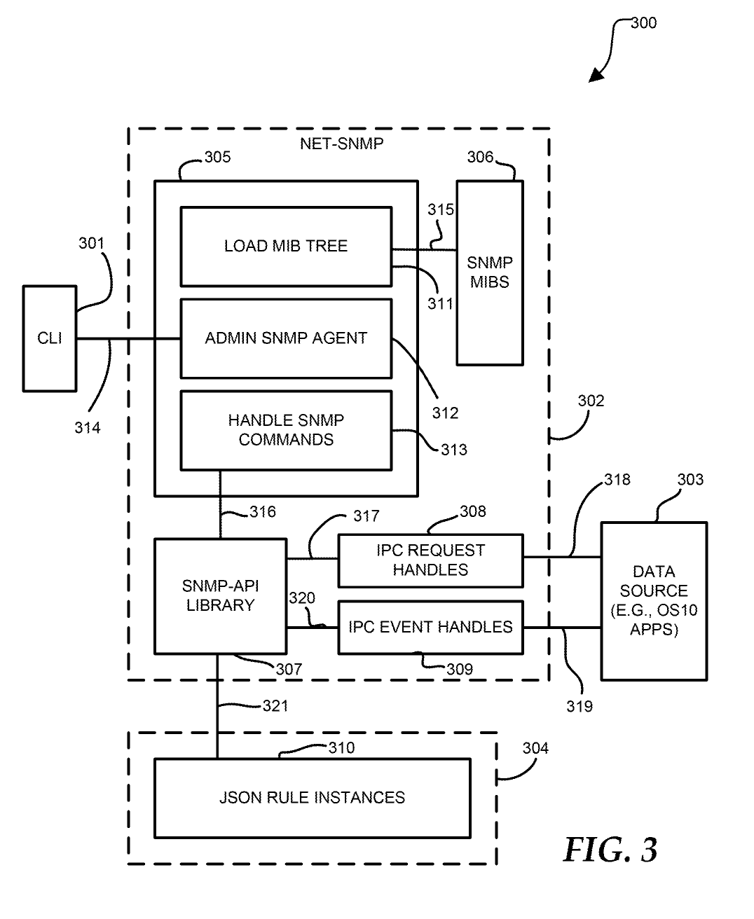

FIG. 3 shows a system 300 including a command line interface (CLI) 301, NET-SNMP block 302, a data source 303, and JSON rule instances subsystem 304. JSON rule instances subsystem 304 stores JSON rule instances 310. NET-SNMP block 302 comprises a subsystem 305. Subsystem 305 comprises load MIB tree block 311 for loading a MIB tree, administer SNMP agent block 312 for administering the SNMP agent, and handle SNMP commands block 313 for handling SNMP commands. NET-SNMP block 302 further comprises SNMP MIBs block 306, SNMP-API library block 307, IPC request handles block 308, and IPC event handles block 309.

Load MIB tree block 311 loads an MIB tree from SNMP MIBs block 306 via input 315. Administer SNMP agent block 312 receives commands from CLI 301 via input 314. Handle SNMP commands block 313 uses SNMP-API library block 307 via interface 316 to receive JSON rule instances 310 via input 321. SNMP-API library block 307 sends requests to IPC request handles block 308 via interface 317. IPC request handles block 308 sends requests to data source 303 via interface 318. Data source 303 provides indications of outstanding events via interface 319 to IPC event handles block 309. IPC event handles block 309 sends indications of outstanding events via interface 320 to SNMP-API library block 307. In accordance with at least one embodiment, IPC requests handles block 308 can be implemented as a CPS request handles block using a CPS open-source IPC. In accordance with at least one embodiment, IPC event handles block 309 can be implemented as a CPS event handles block using the CPS open-source IPC. In accordance with a least one embodiment, data source 303 can include Dell EMC network operating system OS10 applications (apps).

In accordance with at least one embodiment, a Net-SNMP agent and its dynamic object loading method are used. In accordance with at least one embodiment, CPS open source IPC from OPX and Dell EMC network operating system OS10 are used to illustrate a possible implementation. Below figure shows the high-level block diagram of rule based SNMP agent framework.

A data source (collector) application obtains data to be stored in a MIB. In accordance with at least one embodiment, a MIB is created in the Net-SNMP MIB repository folder, JSON mapping rules are defined in the library, and the SNMP agent is reloaded. The SNMP service is immediately available without system downtime.

In accordance with at least one embodiment, a mapping rule has a form as set forth below.

```
{
  ″MIB-OID″: object identifier,
  ″MIB-NAME″: obect name,
  ″MIB-SPEC″:
    {
      ″OBJECTS″: [
        {
          ″OBJECT″: addressable target object,
          ″KEYS″: [
            {
              ″ATTRIBUTE″: key attribute,
              ″SUBID″: sub oid
            }
          ],
          ″ATTRIBUTES″: [
            {
              ″ATTRIBUTE″: data attribute,
              ″SUBID″: sub oid,
              ″XFMR″: transformer method
            },
            {
              ″ATTRIBUTE″: data attribute,
              ″SUBID″: sub oid
            }
          ]
        }
    }
}
```

The object identifiers (OIDs) queried by SNMP commands match JSON rules that find a target object and its attribute values. When an object identifier matches a rule, it is processed by the command handler to send a request to the data source. When the data source application retrieves the data and returns the resulting attribute to the handler, the SNMP agent creates an SNMP response packet. If network devices need to transform the internal value to SNMP-typed values, the transformer method can be used to replace the value.

Notification is implemented as a rule to receive an event from a monitored entities. Testing of pre-defined conditions by comparison logic and notification of SNMP traps in a pre-defined format can be performed.

```
{
  ″OBSERVED-OBJ″: monitored object,
  ″TRAP-SPEC″: [
    {
      ″TRAP-TYPE″: SNMP TRAP TYPE,
      ″TRAP-OID″: trap object identifier,
      ″TEST″: {
        ″ATTRIBUTE″: monitored attribute,
        ″OPERATOR″: comparison operator,
        ″EXPECT″: expected value
      },
      ″TRAP-ATTRS″: [
        {
          ″ATTRIBUTE″: attribute,
          ″OID″: object identifier
        },
        {
          ″ATTRIBUTE″: attribute,
          ″OID″: object identifier,
          ″TRANSFORMER″: transformer method
        }
      ]
    }
}
```

Network vendors define addressable objects in various modeling languages. As an example, the OS10 pluggable SNMP agent uses the YANG modeling language and the path to identify addressable objects and attributes, which can be used for implementation of JSON mapping rules.

### Example of Semantics for JSON Mapping Rules

| Properties | Description |
|---|---|
| MIB-OID | a MIB object identifier in a MIB. For a |
| | tabular MIB object, this is the OID of the |
| | immediate parent of terminal nodes; for |
| | example, the ifTable OID is the MIB-OID |
| | of ifEntry. For scalar groups of objects, |
| | the MIB-OID is OID of the parent object; |
| | for example, the OID for ifNumber |
| | is the OID of interfaces. |
| MIB-NAME | a MIB object name defined in the |
| | MIB for a MIB-OID |
| MIB-SPEC | a set of data sources retrieved for |
| | the MIB object |
| OBJECTS | a set of OS10 CPS objects to be queried |
| | using an SNMP get operation |
| OBJECT | a target CPS object for CPS operations; |
| | a string of YANG path (in Xpath |
| | format) that identifies the CPS object. |
| KEYS | an ordered list of one or more CPS key |
| | attributes used to query the target CPS |
| | object. The KEYS section can be omitted |
| | for a nested yang object and scalar |
| | group of objects; for example, |
| | “if/interfaces-state/interface/statistics” |
| | object in ifTable.json and |
| | ifnumber in interfaces.json. |
| ATTRIBUTES | a sequence of one or more CPS attributes |
| | that correspond to the terminal node/column |
| | whose parent is the MIB-OID. |
| | ATTRIBUTES is also the YANG |
| | path string to the attribute |
| OID | alternatively used to define a full |
| | object identifier in a MIB. OID |
| | is used for foreign keys or an |
| | augmented table in the MIB |
| TRANSFORMER | a method dynamically bound to |
| | SNMP-API library to overwrite an |
| | attribute value returned from the |
| | CPS query with the value in a |
| | format acceptable to SNMP; for |
| | example, ifName in ifTable is |
| | transformed from e101-001-0 or ethernet1/1/1 |
| PARENT_OBJECT | identifies the target parent CPS object |
| | for an OBJECT. Use PARENT_OBJECT |
| | to map a flat MD3 structure to a hierarchical |
| | format of network objects in network devices. |

In accordance with at least one embodiment, a SNMP MIB has a table or group of scalar objects as a flat structure. All terminal nodes can be at the same hierarchy level in the MIB. However, many modern modeling languages, such as YANG, may have a hierarchical structure, in accordance with at least one embodiment, instead of a flat structure.

An example of a JSON template for mapping rules is set forth below.

```
{
  ″MIB-OID″ : <Mib OID string>,
  ″MIB-NAME″ : <MIB object name defined in a MIB>,
  ″MIB-SPEC″: {
    ″OBJECTS″ : [
      {
        ″OBJECT″: <CPS object yang path string>,
        ″KEYS″: [
          {
            ″ATTRIBUTE″ : <CPS object key attribute yang
            path string>,
            ″SUBID″ : <Mib object terminal ID as string>
          }
        ],
        ″ATTRIBUTES″ : [
          {
            ″ATTRIBUTE″ : <CPS object key attribute yang
            path string>,
            ″SUBID″ : <Mib object terminal ID as string>,
            ″TRANSFORMER″ : <transform function name
            string>
          },
          .
          .
          .
          {
            ″ATTRIBUTE″ : <CPS object key attribute yang
            path string>,
            ″SUBID″ : <Mib object terminal ID as string>
          }
        ]
      },
      {
        ″OBJECT″ : ″″,
        ″KEYS″ : [
          {
            ″ATTRIBUTE″ : ″″,
            ″SUBID″ : ″″
          }
        ],
        ″ATTRIBUTES″: [
          {
            ″ATTRIBUTE″ : ″″,
            ″SUBID″ : ″″
          },
          .
          .
          .
          {
            ″ATTRIBUTE″ : ″″,
            ″SUBID″ : ″″
          }
        ]
      },
      {
        ″OBJECT″ : ″″,
        ″PARENT_OBJECT″ : <Parent CPS object whose cps
key is used to query this object>,
        ″ATTRIBUTES″ : [
          {
            ″ATTRIBUTE″ : ″″,
            ″SUBID″ : ″″
          },
          .
          .
          .
          {
            ″ATTRIBUTE″ : ″″,
            ″SUBID″ : ″″
          }
        ]
      }
    ]
  }
}
```

In accordance with at least one embodiment, an example of semantics for JSON mapping rules for SNMP traps is set forth below. A directive can be defined to receive an internal IPC-based event from tarp source and to compare the predefined rule to determine whether to send SMMP notifications.

### Example of Semantics for JSON Mapping Rules for SNMP Traps

| Properties | Description |
|---|---|
| OBSERVED-OBJ | a monitored object subscribed by SNMP-API |
| | library to monitor events |
| MIB-NAME | a MIB object name defined in a MIB |
| TRAP-SPEC | a set of traps defined a MIB |
| TRAP-TYPE | a SNMP notification name defined in a MIB |
| TRAP-OID | an object identifier for a notification defined |
| | in a MIB |
| TEST | a comparison operator to evaluate if this |
| | event triggers a SNMP trap. |
| | Note that, if “TEST”: { }, it is evaluated to True |
| OPERATOR | { ‘==‘, ‘!=‘, ‘>‘, ‘>=‘, ‘<‘, ‘<= } |
| EXPECT | an expected value, e.g. 2 is oper-down |
| TRAP-ATTRS | a sequence of zero or more attributes which |
| | become part of SNMP trap PDU |

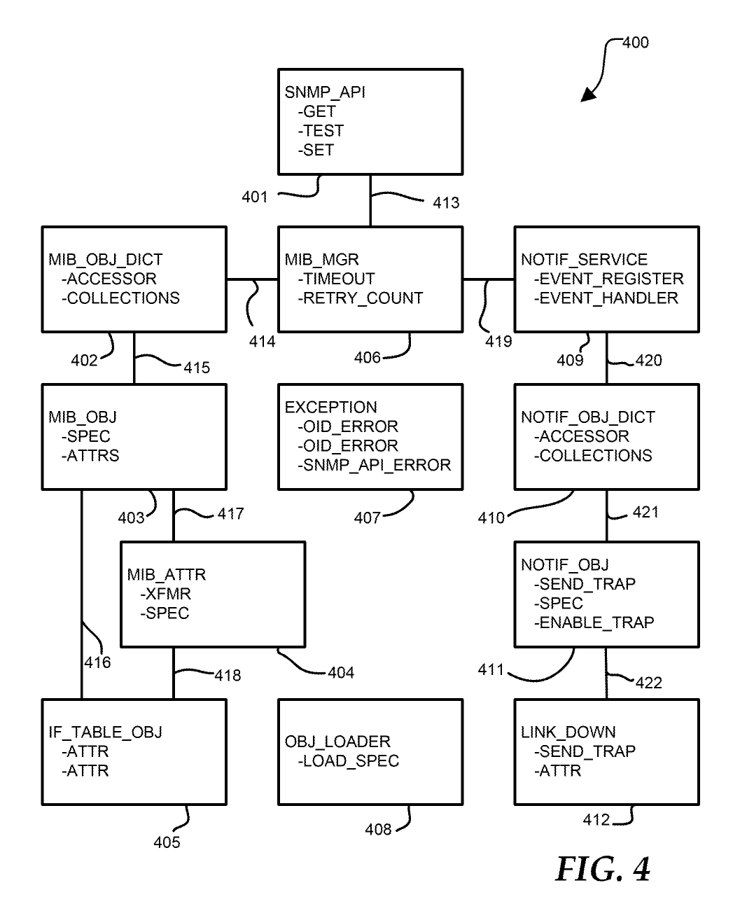

FIG. 4 is a block diagram illustrating classes for a simple network management protocol application programming interface (SNMP-API) library in accordance with at least one embodiment. System 400 includes SNMP_API block 401, MIB_MGR block 406, MIB_OBJ_DICT block 402, MIB_OBJ block 403, MIB_ATTR block 404, IF_TABLE_OBJ block 405, NOTIF_SERVICE block 409, NOTIF_OBJ_DICT block 410, NOTIF_OBJ block 411, LINK_DOWN block 412, EXCEPTION block 407, and OBJ_LOADER block 408. SNMP_API block 401 comprises functional units for the GET, TEST, and SET SNMP operations. SNMP_API block 401 is coupled to MIB_MGR (MIB manager) block 406 via connection 413. MIB_MGR block 406 comprises functional units for TIMEOUT and RETRY_COUNT functions. MIB_MGR block 406 is coupled to MIB_OBJ_DICT block 402 via connection 414. MIB_OBJ_DICT block 402 comprises functional units for ACCESSOR and COLLECTIONS functions. MIB_OBJ_DICT block 402 is coupled to MIB_OBJ block 403 via connection 415. MIB_OBJ block 403 comprises functional units for SPEC and ATTRS functions. MIB_OBJ block 403 is coupled to MIB_ATTR block 404 via connection 417. MIB_ATTR block 404 comprises functional units for XFMR and SPEC functions. MIB_ATTR block 404 is coupled to IF_TABLE_OBJ via connection 418. MIB_OBJ block 403 is coupled to IF_TABLE_OBJ block 405 via connection 416. IF_TABLE_OBJ block 405 comprises functional units for one or more ATTR functions.

MIB_MGR block 406 is coupled to NOTIF_SERVICE block 409 via connection 419. NOTIF_SERVICE block 409 comprises functional units for EVENT_REGISTER and EVENT_HANDLER functions. NOTIF_SERVICE block 409 is coupled to NOTIF_OBJ_DICT block 410 via connection 420. NOTIF_OBJ_DICT block 410 comprises functional units for ACCESSOR and COLLECTIONS functions. NOTIF_OBJ_DICT block 410 is coupled to NOTIF_OBJ block 411 via connection 421. NOTIF_OBJ block 411 comprises functional units for SEND_TRAP, SPEC, and ENABLE_TRAP functions. NOTIF_OBJ block 411 is coupled to LINK_DOWN block 412. LINK_DOWN block 412 comprises functional units for SEND_TRAP and ATTR functions. System 400 comprises EXCEPTION block 407, which comprises functional units for one or more OID_ERROR and SNMP_API ERROR functions. System 400 comprises OBJ_LOADER block 408, which comprises a functional unit for a LOAD_SPEC function.

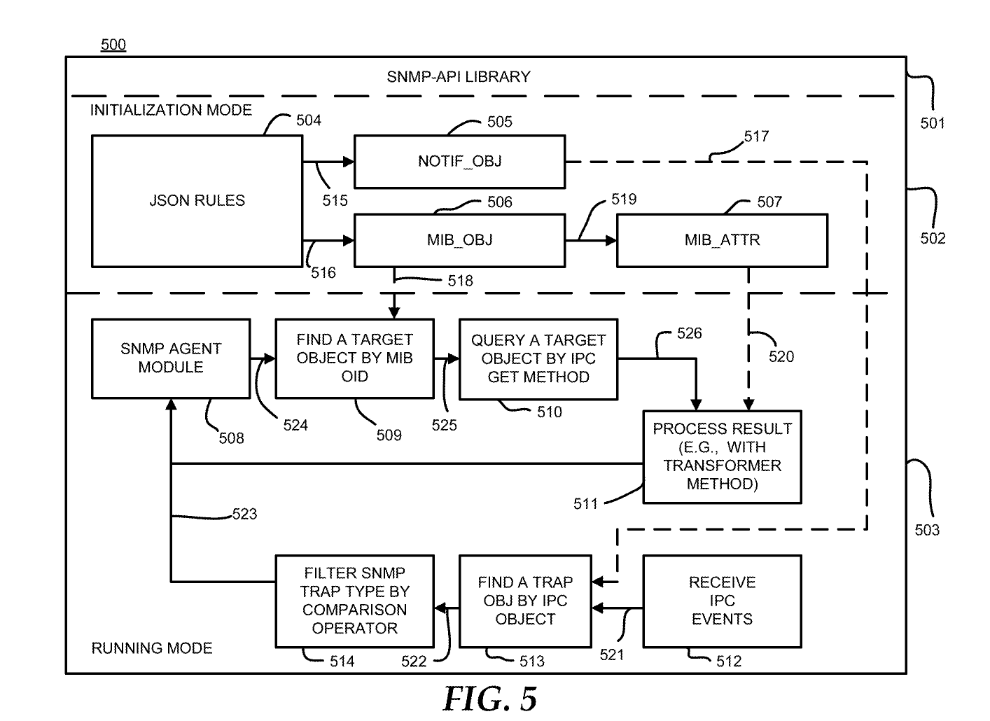

FIG. 5 illustrates a method 500 that can be implemented according to SNMP-API library 501. Method 500 includes an initialization mode 502 and a running mode 503. Initialization mode 502 includes the provision of JSON rules 504 to NOTIF_OBJ block 505 via connection 515, the provision of JSON rules 504 to MIB_OBJ block 506 via connection 516, and the provision of an MIB OID to MIB_ATTR block 507 via connection 519. MIB_OBJ block 506 provides the MIB OID to block 509 of running mode 503 via connection 518. MIB_ATTR block 507 provides a MIB attribute to block 511 of running mode 503 via connection 520. NOTIF_OBJ block 505 provides information for event filtering and testing to block 513 of running mode 503 via connection 517. Running mode 503 comprises blocks 508, 509, 510, 511, 512, 513, and 514. Block 508 comprises a SNMP agent module, which provides its output to block 509 via connection 524. Block 509 finds a target object according to a MIB OID, such as the MIB OID received from MIB_OBJ 506 via connection 518. Block 509 provides its output to block 510 via connection 525. Block 510 queries a target object using an IPC “get” method. Block 510 provides its output to block 511 via connection 526. Block 511 processes a result (e.g., using a transformer method) and provides its output to SNMP agent module 508 via connection 523. Block 512 receives IPC events and provides an indication of an outstanding event to block 513 via connection 521. Block 513 finds a trap object according to a IPC object and provides an output to block 514. Block 514 filters the SNMP trap type according to a comparison operator and provides a filtered indication to SNMP agent module 508 via output 523.

The SNMP API library is a component that generically handles commands and executes operations based on the network vendor IPC and public get and set operations. JSON mapping rules are loaded and instantiated in a memory structure that allows the SNMP API modules to execute as a generic command handler.

The SNMP command processing flow is shown in FIG. 5. After an SNMP request is received, the SNMP agent calls the Get method of the snmpAPI class and filters a mibObject by a O(1)-based (constant time complexity) search using the MIB object identifier (OID). When the mibObject is found, the CPS/IPC get request is generically invoked to query the data source application to fetch a value. When a successful query is performed, a returned value is processed with the mibAttr object specific to the attribute. If a transformer method is bound to the attribute, it is processed before sending the resulting attribute to the SNMP agent.

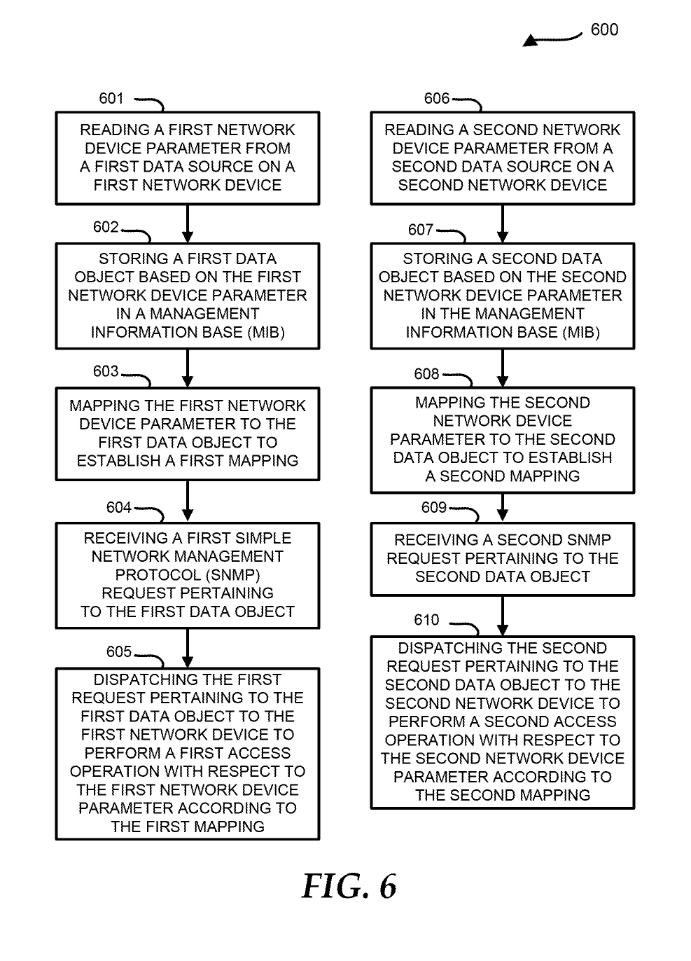

FIG. 6 illustrates a method 600 that includes two sets of blocks. A first set of blocks 601 to 605 pertains to a first network device. A second set of blocks 606 to 610 pertains to a second network device. The blocks of the two sets of blocks may occur in a sequential or interleaved manner with respect to each other.

The first set begins at block 601, where a first network device parameter is read from a first data source on a first network device. From block 601, method 600 continues to block 602. At block 602, a first data object based on the first network device parameter is stored in a MIB. From block 602, method 600 continues to block 603. At block 603, the first network device parameter is mapped to the first data object to establish a first mapping. From block 603, method 600 continues to block 604. At block 604, a first SNMP request pertaining to the first data object is received. From block 604, method 600 continues to block 605. At block 605, the first request pertaining to the first data object is dispatched to the first network device to perform a first access operation with respect to the first network device parameter according to the first mapping.

The second set begins at block 606, where a second network device parameter is read from a second data source on a second network device. From block 606, method 600 continues to block 607. At block 607, a second data object based on the second network device parameter is stored in a MIB. From block 607, method 600 continues to block 608. At block 608, the second network device parameter is mapped to the second data object to establish a second mapping. From block 608, method 600 continues to block 609. At block 609, a second SNMP request pertaining to the second data object is received. From block 609, method 600 continues to block 610. At block 610, the second request pertaining to the second data object is dispatched to the second network device to perform a second access operation with respect to the second network device parameter according to the second mapping.

In accordance with at least one embodiment, SNMP objects and traps may be implemented as set forth below.

/opt/dell/os10/lib/python/os10/snmp_api
|-- _init_.py
|-- exceptions.py
|-- mib_attr.py
|-- mib_attr.pyc
|-- mib_mgr.py
|-- mib_mgr.pyc
|-- mib_notif_spec.py
|-- mib_obj.py
|-- mib_obj.pyc
|-- mib_obj_dict.py
|-- mib_obj_dict.pyc
|-- mib_spec.py
|-- mib_spec.pyc
|-- notif_obj.py
|-- notif_obj.pyc
|-- notif_obj_dict.py
|-- notif_obj_dict.pyc
|-- notif_service.py
|-- notif_service.pyc
|-- objects
| ′-- ifMib
| |-- ifTable.json
| |-- interfaces.json
| |-- xfmr.py
| ′-- xfmr.pyc
|-- snmp_api.py
|-- snmp_api.pyc
|-- traps
| ′-- ifMib
| |-- linkStatus.json
| |-- xfmr.py
| ′-- xfmr.pyc
′-- unittests.py

In accordance with at least one embodiment, an example of a JSON mapping rule for IfTable is set forth below.

```
{
  ″MIB-OID″ : ″1.3.6.1.2.1.2.2″,
  ″MIB-NAME″: ″ifTable″,
  ″MIB-SPEC″:
    {
      ″OBJECTS″: [
        {
          ″OBJECT″: ″if/interfaces/interface″,
          ″KEYS″: [
            {
              ″ATTRIBUTE″: ″if/interfaces-state/interface/if-index″,
              ″SUBID″: ″1″
            }
          ],
          ″ATTRIBUTES″: [
            {
              ″ATTRIBUTE″: ″if/interfaces/interface/type″,
              ″SUBID″: ″3″
            },
            {
              ″ATTRIBUTE″: ″dell-if/if/interfaces/interface/mtu″,
              ″SUBID″: ″4″
            }
          ]
        },
        {
          ″OBJECT″: ″if/interfaces-state/interface″,
          ″KEYS″: [
            {
              ″ATTRIBUTE″: ″if/interfaces-state/interface/if-index″,
              ″SUBID″: ″1″
            }
          ],
          ″ATTRIBUTES″: [
            {
              ″ATTRIBUTE″: ″if/interfaces-state/interface/name″,
              ″SUBID″: ″2″,
              ″TRANSFORMER″: ″xfmr_name″
            },
            {
              ″ATTRIBUTE″: ″dell-infra-if/if/interfaces-state/interface/
base-oper-status″,
              ″SUBID″: ″8″
            }
          ]
        }
      ]
    }
}
```

In accordance with at least one embodiment, an example of a JSON mapping rule for a LinkUp or a LinkDown trap is set forth below.

```
{
  ″OBSERVED-OBJ″: ″if/interfaces-state/interface″,
  ″TRAP-SPEC″: [
    {
      ″TRAP-TYPE″: ″LinkDown″,
      ″TRAP-OID″: ″1.3.6.1.6.3.1.1.5.3″,
      ″TEST″: {
        ″ATTRIBUTE″: ″if/interfaces-state/interface/oper-status″,
        ″OPERATOR″: ″==″,
        ″EXPECT″: 2
      },
      ″TRAP-ATTRS″: [
        {
          ″ATTRIBUTE″: ″if/interfaces-state/interface/if-index″,
          ″OID″: ″1.3.6.1.2.1.2.2.1.1″
        },
        {
          ″ATTRIBUTE″: ″if/interfaces-state/interface/admin-status″,
          ″OID″: ″1.3.6.1.2.1.2.2.1.7″,
          ″TRANSFORMER″: ″xfmr_admin_status″
        },
        {
          ″ATTRIBUTE″: ″if/interfaces-state/interface/oper-status″,
          ″OID″: ″1.3.6.1.2.1.2.2.1.8″
        }
      ]
    },
    {
      ″TRAP-TYPE″: ″LinkUp″,
      ″TRAP-OID″: ″1.3.6.1.6.3.1.1.5.4″,
      ″TEST″: {
        ″ATTRIBUTE″: ″if/interfaces-state/interface/oper-status″,
        ″OPERATOR″: ″==″,
        ″EXPECT″: 1
      },
      ″TRAP-ATTRS″: [
        {
          ″ATTRIBUTE″: ″if/interfaces-state/interface/if-index″,
          ″OID″: ″1.3.6.1.2.1.2.2.1.1″
        },
        {
          ″ATTRIBUTE″: ″if/interfaces-state/interface/admin-status″,
          ″OID″: ″1.3.6.1.2.1.2.2.1.7″,
          ″TRANSFORMER″: ″xfmr_admin_status″
        },
        {
          ″ATTRIBUTE″: ″if/interfaces-state/interface/oper-status″,
          ″OID″: ″1.3.6.1.2.1.2.2.1.8″
        }
      ]
    }
  ]
}
```

At least one embodiment can be implemented to provide advantages of a rule-based SNMP agent system and method over traditional SNMP techniques. As an example, rule-based access to a data source and rule-based trap generation can be implemented. As another example, an implementation can be generic to a plurality of otherwise incompatible network vendor IPCs if data is accessed through addressable objects. As a further example, an implementation can be pluggable as needed, by storing a MIB, define a JSON directive, and retrieve data in a data source application. As yet another example, an implementation can eliminate extra hops using direct access to data source. Furthermore, as an example, a data-type transformer method can transform internal data to SNMP typed data. Advantageously, in accordance with at least one embodiment, O(1)-based (constant time) lookup for a rule can be provided, reducing lengthy times that would otherwise be required. As a further example, a comparison operator can be used to quickly and efficiently filter a specified SNMP trap type, such as a throttle threshold-based trap. As yet another example, extensible semantics are applicable to other NBIs, such as Restful API. As another example, rapid SNMP agent development can be enabled, reducing development time as compared with traditional techniques.

In accordance with at least one embodiment, JSON rules can be defined to effectively map MIB objects and network objects defined by vendors. A generic command and response handler can be implemented to use the JSON rules to fetch data from various data sources. Accordingly, a method is provided that, in accordance with at least one embodiment, can eliminate writing SNMP data access codes and can greatly simply the SNMP agent development process.

In accordance with at least one embodiment, a method comprises reading, using an inter-process communication (IPC) command handler, a first network device parameter from a first data source on a first network device, reading, using the IPC command handler, a second network device parameter from a second data source on a second network device, the first network device being of a first type and the second network device being of a second type, the second type being different from the first type, storing a first data object based on the first network device parameter in a management information base (MIB), storing a second data object based on the second network device parameter in the MIB, mapping the first network device parameter to the first data object to establish a first mapping, mapping the second network device parameter to the second data object to establish a second mapping, receiving a first simple network management protocol (SNMP) request pertaining to the first data object, dispatching the first request pertaining to the first data object to the first network device to perform a first access operation with respect to the first network device parameter according to the first mapping, receiving a second SNMP request pertaining to the second data object, and dispatching a second request pertaining to the second data object to the second network device to perform a second access operation with respect to the second network device parameter according to the second mapping. In accordance with at least one embodiment, the mapping the first network device parameter to the first data object and mapping the second network device parameter to the second data object are performed according to a mapping rule using a scripting language object notation structure. In accordance with at least one embodiment, the scripting language object notation structure is a Javascript object notation (JSON) structure. In accordance with at least one embodiment, the first SNMP request is selected from a group consisting of a SNMP get request, a SNMP test request, and a SNMP set request, and wherein the second SNMP request is selected from the group consisting of the SNMP get request, the SNMP test request, and the SNMP set request. In accordance with at least one embodiment, the method is performed by an SNMP agent executing on an information handling system. In accordance with at least one embodiment, the method further comprises detecting a first network device condition of the first network device and storing a third data object in the MIB corresponding to the first network device condition. In accordance with at least one embodiment, the method further comprises sending a SNMP trap to a subscriber. In accordance with at least one embodiment, the first data object is representative of a first network device data object specific to a first network device vendor format of a first network device vendor of the first network device, and the second data object is stored as a second network device data object specific to a second network device vendor format of a second network device vendor of the second network device.

In accordance with at least one embodiment, an information handling system comprises a memory for storing instructions, a processor coupled to the memory for executing the instructions, and a network interface coupled to the processor for providing communications over a network in response to execution of the instructions, the instructions configured to cause the information handling system to read, using an inter-process communication (IPC) command handler, a first network device parameter from a first data source on a first network device, to read, using the IPC command handler, a second network device parameter from a second data source on a second network device, the first network device being of a first type and the second network device being of a second type, the second type being different from the first type, to store a first data object based on the first network device parameter in a management information base (MIB), to store a second data object based on the second network device parameter in the MIB, to map the first network device parameter to the first data object to establish a first mapping, to map the second network device parameter to the second data object to establish a second mapping, to receive a first simple network management protocol (SNMP) request pertaining to the first data object, to dispatch the first request pertaining to the first data object to the first network device to perform a first access operation with respect to the first network device parameter according to the first mapping, to receive a second SNMP request pertaining to the second data object, and to dispatch a second request pertaining to the second data object to the second network device to perform a second access operation with respect to the second network device parameter according to the second mapping. In accordance with at least one embodiment, the mapping the first network device parameter to the first data object and mapping the second network device parameter to the second data object are performed according to a mapping rule using a scripting language object notation structure. In accordance with at least one embodiment, the scripting language object notation structure is a Javascript object notation (JSON) structure. In accordance with at least one embodiment, the first SNMP request is selected from a group consisting of a SNMP get request, a SNMP test request, and a SNMP set request, and wherein the second SNMP request is selected from the group consisting of the SNMP get request, the SNMP test request, and the SNMP set request. In accordance with at least one embodiment, the information handling system implements a SNMP agent. In accordance with at least one embodiment, the information handling system is further configured to detect a first network device condition of the first network device; and to store a third data object in the MIB corresponding to the first network device condition. In accordance with at least one embodiment, the information handling system is further configured to send a SNMP trap to a subscriber. In accordance with at least one embodiment, the first data object is representative of a first network device data object specific to a first network device vendor format of a first network device vendor of the first network device, and the second data object is stored as a second network device data object specific to a second network device vendor format of a second network device vendor of the second network device.

In accordance with at least one embodiment, an information handling system comprises a memory for storing instructions, a processor coupled to the memory for executing the instructions, and a network interface coupled to the processor for providing communications over a network in response to execution of the instructions, the instructions configured to cause the information handling system to implement a simple network management protocol (SNMP) application programming interface (API) service, the SNMP API service, in accordance with mapping rules for a management information base (MIB) object identifier (OID) and a target network object, to receive an SNMP operation from a SNMP agent, to dispatch a model-based query to a network object owner, to perform a transformation on the SNMP operation, to obtain a response from the network object owner, and to provide a SNMP response packet data unit (PDU) based on a transformation output of the transformation and on the response from the network object owner. In accordance with at least one embodiment, the information handling system is further configured to provide the SNMP response PDU to the SNMP agent. In accordance with at least one embodiment, the information handling system is further configured to implement a notification service to receive an indication of an outstanding event from the network object owner, to filter the indication of the outstanding event, and to generate a SNMP trap based on the filtered indication of the outstanding event. In accordance with at least one embodiment, the information handling system is further configured to provide the SNMP trap to the SNMP agent.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (such as random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
reading, using an inter-process communication (IPC) command handler, a first network device parameter from a first data source on a first network device;
reading, using the IPC command handler, a second network device parameter from a second data source on a second network device, the first network device being of a first type and the second network device being of a second type, the second type being different from the first type;
storing a first data object based on the first network device parameter in a management information base (MIB);
storing a second data object based on the second network device parameter in the MIB;
mapping the first network device parameter to the first data object to establish a first mapping;
mapping the second network device parameter to the second data object to establish a second mapping;
receiving a first simple network management protocol (SNMP) request pertaining to the first data object;
dispatching the first request pertaining to the first data object to the first network device to perform a first access operation with respect to the first network device parameter according to the first mapping;
receiving a second SNMP request pertaining to the second data object; and
dispatching a second request pertaining to the second data object to the second network device to perform a second access operation with respect to the second network device parameter according to the second mapping.

2. The method of claim 1, wherein the mapping the first network device parameter to the first data object and mapping the second network device parameter to the second data object are performed according to a mapping rule using a scripting language object notation structure.

3. The method of claim 2, wherein the scripting language object notation structure is a Javascript object notation (JSON) structure.

4. The method of claim 1, wherein the first SNMP request is selected from a group consisting of a SNMP get request, a SNMP test request, and a SNMP set request, and wherein the second SNMP request is selected from the group consisting of the SNMP get request, the SNMP test request, and the SNMP set request.

5. The method of claim 1, wherein the method is performed by an SNMP agent executing on an information handling system.

6. The method of claim 1, further comprising:
detecting a first network device condition of the first network device; and
storing a third data object in the MIB corresponding to the first network device condition.

7. The method of claim 1, further comprising:
sending a SNMP trap to a subscriber.

8. The method of claim 1, wherein the first data object is representative of a first network device data object specific to a first network device vendor format of a first network device vendor of the first network device, and the second data object is stored as a second network device data object specific to a second network device vendor format of a second network device vendor of the second network device.

9. An information handling system comprising:
a memory for storing instructions;
a processor coupled to the memory for executing the instructions; and
a network interface coupled to the processor for providing communications over a network in response to execution of the instructions, the instructions configured to cause the information handling system to read, using an inter-process communication (IPC) command handler, a first network device parameter from a first data source on a first network device, to read, using the IPC command handler, a second network device parameter from a second data source on a second network device, the first network device being of a first type and the second network device being of a second type, the second type being different from the first type, to store a first data object based on the first network device parameter in a management information base (MIB), to store a second data object based on the second network device parameter in the MIB, to map the first network device parameter to the first data object to establish a first mapping, to map the second network device parameter to the second data object to establish a second mapping, to receive a first simple network management protocol (SNMP) request pertaining to the first data object, to dispatch the first request pertaining to the first data object to the first network device to perform a first access operation with respect to the first network device parameter according to the first mapping, to receive a second SNMP request pertaining to the second data object, and to dispatch a second request pertaining to the second data object to the second network device to perform a second access operation with respect to the second network device parameter according to the second mapping.

10. The information handling system of claim 9, wherein the mapping the first network device parameter to the first data object and mapping the second network device parameter to the second data object are performed according to a mapping rule using a scripting language object notation structure.

11. The information handling system of claim 10, wherein the scripting language object notation structure is a Javascript object notation (JSON) structure.

12. The information handling system of claim 9, wherein the first SNMP request is selected from a group consisting of a SNMP get request, a SNMP test request, and a SNMP set request, and wherein the second SNMP request is selected from the group consisting of the SNMP get request, the SNMP test request, and the SNMP set request.

13. The information handling system of claim 9, wherein the information handling system implements a SNMP agent.

14. The information handling system of claim 9, wherein the information handling system is further configured to detect a first network device condition of the first network device; and to store a third data object in the MIB corresponding to the first network device condition.

15. The information handling system of claim 9, wherein the information handling system is further configured to send a SNMP trap to a subscriber.

16. The information handling system of claim 9, wherein the first data object is representative of a first network device data object specific to a first network device vendor format of a first network device vendor of the first network device, and the second data object is stored as a second network device data object specific to a second network device vendor format of a second network device vendor of the second network device.

17. An information handling system comprising:
a memory for storing instructions;
a processor coupled to the memory for executing the instructions; and
a network interface coupled to the processor for providing communications over a network in response to execution of the instructions, the instructions configured to cause the information handling system to implement a simple network management protocol (SNMP) application programming interface (API) service, the SNMP API service, in accordance with mapping rules for a management information base (MIB) object identifier (OID) and a target network object, to receive an SNMP operation from a SNMP agent, to dispatch a model-based query to a network object owner, to perform a transformation on the SNMP operation, to obtain a response from the network object owner, and to provide a SNMP response packet data unit (PDU) based on a transformation output of the transformation and on the response from the network object owner.

18. The information handling system of claim 17, further configured to provide the SNMP response PDU to the SNMP agent.

19. The information handling system of claim 17, further configured to implement a notification service to receive an indication of an outstanding event from the network object owner, to filter the indication of the outstanding event, and to generate a SNMP trap based on the filtered indication of the outstanding event.

20. The information handling system of claim 19, further configured to provide the SNMP trap to the SNMP agent.
